(19) United States
(12) Patent Application Publication
(10) Pub. No.: US 2021/0113992 A1
(43) Pub. Date: Apr. 22, 2021

(54) BIOLOGICAL MORPH-GENETIC WO3 PHOTOCATALYST AND PREPARATION METHOD AND APPLICATION THEREOF

(71) Applicant: Jilin Jianzhu University, Changchun (CN)

(72) Inventors: Yingzi Lin, Changchun (CN); Yang Zhu, Changchun (CN); Ang Li, Changchun (CN); Huan Lin, Changchun (CN); Zeming Zhao, Changchun (CN); Gen Liu, Changchun (CN)

(21) Appl. No.: 16/725,932

(22) Filed: Dec. 23, 2019

(30) Foreign Application Priority Data
Oct. 21, 2019 (CN) 201910997511.8

(51) Int. Cl. B01J 23/30; C01G 41/02; B01J 35/00; B01J 37/02; B01J 37/08; B01J 37/06; C02F 1/32; C02F 1/72

(52) U.S. Cl. CPC B01J 23/30; C02F 2101/308; B01J 35/004; B01J 37/0205; B01J 37/0207; B01J 37/088; B01J 37/06; C02F 1/32; C02F 1/725; C01P 2002/72; C01P 2004/03; C01P 2004/04; C01P 2002/85; C02F 2305/10; C01G 41/02

(57) ABSTRACT

The present invention provides a biological morph-genetic WO3 photocatalyst and a preparation method and application thereof, and belongs to the technical field of photocatalysis The preparation method of the present invention includes the following steps: impregnating a rice husk into a tungsten source solution, and roasting an obtained solid material after solid-liquid separation to obtain the biological morph-genetic WO₃ photocatalyst. The present invention utilizes the rice husk as a biological template agent; the rice husk contains a large amount of silicon dioxide, and has a silicon-carbon network structure; the rice husk is impregnated into the tungsten source solution, and after roasting, a tungsten source replicates the silicon-carbon network structure of the rice husk, forming a hierarchical structure including a micropore and a mesopore with good adsorption; at the same time, during the roasting process, the carbon of the rice husk is doped into a lattice of the WO₃, which facilitates transfer between charges in the lattice of the WO₃, reduces a forbidden band width of the WO₃, and improves the photocatalytic reaction performance of the WO₃.

### TECHNICAL FIELD

The present invention relates to the technical field of photocatalysis, and in particular, to a biological morph-genetic WO₃ photocatalyst and a preparation method and application thereof.

### BACKGROUND

Biomimetic materials have become a hotspot in scientific research because of their superiorities such as unique structure, wide range of raw materials, low cost, and simple preparation methods. Materials having a micro- or nano-scale structure and inheriting a unique morphological structure of original organisms are designed and developed by using bio-inspired or mimicked various functions, structures and compositions of biomimetic organisms, and can be applied to the fields of environment, optics, energy and the like. Templates such as plants, animals and microorganisms used in biomimetic materials include almost the entire ecosystem.

Gao Xue et al. prepared a nano-zinc oxide with a hexagonal wurtzite structure by using rapeseed pollen as a biological template and zinc nitrate as a zinc source (Gao Xue, Liu Yutong, Wang Yu et al. Preparation of nano-zinc oxide by biological template method [J]. Chemistry Bulletin, 2019, 82(1) 63:67.); Lian Chang et al. prepared a mesoporous nano-cerium oxide by using chitosan as a biological template (Lian Chang, Li Changbo, Zhao Guozhen, et al. Study on synthesis of porous structure cerium oxide by biological template method and adsorption properties thereof [J]. New Chemical Materials, 2018, 46(9): 202-204.); Robert et al. prepared a soft magnetic eco-ceramic by using cork powder as a biological template (Pullar R C, Marques P, Amaral J, et al. Magnetic wood-based biomorphic Sr₃Co₂Fe₂₄O₄₁ Z-type hexaferrite ecoceramics made from cork templates [J]. Materials & Design, 2015, 82:297-303.); Li Linxuan et al. prepared a modified straw-Fe₃O₄ composite by using modified straw as a biological template (Li Linxuan, Liao Yunkai, Fan Shisuo. Study on removal of methylene blue from dye wastewater by modified straw-Fe₃O₄ composite [J]. Journal of Agro-Environment Science, 2019, 38(5):1130-1141). However, studies on the preparation of WO₃ photocatalysts using a biological template have rarely been reported.

### SUMMARY

An objective of the present invention is to provide a biological morph-genetic WO₃ photocatalyst and a preparation method and application thereof. The WO₃ photocatalyst prepared by the present invention has a hierarchical porous structure, and is applied to the treatment of methylene blue wastewater with a good treatment effect.

To achieve the above purpose, the present invention provides the following technical solutions.

The present invention provides a preparation method of a biological morph-genetic WO₃ photocatalyst, including the following steps: impregnating a rice husk into a tungsten source solution, and roasting an obtained solid material after solid-liquid separation to obtain the biological morph-genetic WO₃ photocatalyst.

Preferably, the preparation method further includes: sequential washing, acid leaching and ammonia water extraction of the rice husk prior to the impregnation.

Preferably, an acid solution used for the acid leaching is hydrochloric acid; the mass concentration of the hydrochloric acid is 5-7%, and the time for the acid leaching is 3-5 hours (“h”).

Preferably, the mass concentration of ammonia water used in the ammonia water extraction is 5-7%, and the extraction time is 3-4 h.

Preferably, a tungsten source of the tungsten source solution is calcium tungstate or tungsten chloride; a solvent of the tungsten source solution is ethanol or methanol; a ratio of the tungsten source to the solvent in the tungsten source solution is (0.1-5) g:40 mL.

Preferably, the time of the impregnation is 46-50 h.

Preferably, the roasting temperature is 540-550° C., and the holding time is 4-6 h; the roasting atmosphere is an air atmosphere.

Preferably, the room temperature is raised to the roasting temperature, and the rising rate is 1.5-2° C./min.

The present invention provides a biological morph-genetic WO₃ photocatalyst prepared by the above preparation method.

The present invention provides an application of the biological morph-genetic WO₃ photocatalyst in treating methylene blue wastewater.

The present invention provides a preparation method of a biological morph-genetic WO₃ photocatalyst, including the following steps: impregnating a rice husk into a tungsten source solution, and roasting an obtained solid material after solid-liquid separation to obtain the biological morph-genetic WO₃ photocatalyst. The present invention utilizes the rice husk as a biological template agent; the rice husk contains a large amount of silicon dioxide, and has a silicon-carbon network structure; the rice husk is impregnated into the tungsten source solution, and after roasting, a tungsten source replicates the silicon-carbon network structure of the rice husk, forming a hierarchical structure including a micropore and a mesopore with good adsorption; at the same time, during the roasting process, the carbon of the rice husk is doped into a lattice of the WO₃, which facilitates transfer between charges in the lattice of the WO₃, reduces a forbidden band width of the WO₃, and improves the photocatalytic reaction performance of the WO₃. A result of an embodiment shows that, when the biological morph-genetic WO₃ photocatalyst prepared by the present invention is used for treating methylene blue wastewater, the degradation rate is significantly higher than that of a commercially available WO₃, indicating that the biological morph-genetic WO₃ photocatalyst prepared by the present invention has good photocatalytic performance.

### BRIEF DESCRIPTION OF THE DRAWINGS

FIG. 1 is an X-ray diffraction (XRD) spectrum of B-WO₃ and E-WO₃;

FIG. 2 is a scanning electron microscope (SEM) photograph of B-WO₃ and E-WO₃;

FIG. 3 is a transmission electron microscope (TEM) photograph of B-WO₃;

FIGS. 4a-4d show x-ray photoelectron spectroscopy (XPS) survey analysis results of B-WO₃;

FIGS. 5a-5b show a N₂ adsorption-desorption isotherm and a BJH pore size distribution curve of B-WO₃ respectively;

FIG. 6 is an ultraviolet-visible diffuse reflectance spectra of B-WO₃ and E-WO₃;

FIG. 7 shows an effect of a concentration of a tungsten source solution on a degradation rate;

FIG. 8 shows degradation of B-WO₃ and E-WO₃ on a methylene blue solution under different conditions;

FIG. 9 shows an effect of an initial concentration of methylene blue on a degradation rate;

FIG. 10 shows an effect of a WO₃ dose on a degradation rate;

FIG. 11 is an ultraviolet-visible absorption spectra of B-WO₃ for degrading methylene blue;

FIG. 12 shows a total organic carbon (TOC) concentration varying with a reaction time when B-WO₃ degrades a methylene blue solution; and

FIG. 13 shows a result of an active species capture experiment.

### DETAILED DESCRIPTION

The present invention provides a preparation method of a biological morph-genetic WO₃ photocatalyst, including the following steps: impregnate a rice husk into a tungsten source solution, and roast an obtained solid material after solid-liquid separation to obtain the biological morph-genetic WO₃ photocatalyst.

In the present invention, the materials used are all commercially available products well known in the art, unless otherwise specified.

The present invention impregnates a rice husk into a tungsten source solution. In the present invention, the rice husk is preferably a rice husk of the season. A tungsten source of the tungsten source solution is preferably calcium tungstate or tungsten chloride, more preferably tungsten chloride; a solvent of the tungsten source solution is preferably ethanol or methanol; a ratio of the tungsten source to the solvent in the tungsten source solution is preferably (0.1-5) g:40 mL, more preferably (0.5-1) g:40 mL, and most preferably 0.793 g:40 mL. In the present invention, a ratio of the rice husk to the tungsten source solution is preferably 50 g:40 mL.

The present invention preferably further includes sequential washing, acid leaching and ammonia water extraction of the rice husk prior to the impregnation. In the present invention, a washing liquid used for the washing is preferably water, and the present invention preferably washes 3 times to remove an impurity on the surface of the rice husk. In the present invention, an acid solution used for the acid leaching is preferably hydrochloric acid; the mass concentration of the hydrochloric acid is preferably 5-7%, more preferably 5%, and the time for the acid leaching is preferably 3-5 h. The present invention has no special requirement for the amount of the hydrochloric acid used in the acid leaching, and an amount that can completely immerse the rice husk can be used. The present invention utilizes the acid leaching to remove a calcium ion from the rice husk. After completion of the acid leaching, the present invention preferably uses water to wash the rice husk after the acid leaching to neutral. In the present invention, the mass concentration of ammonia water used in the ammonia water extraction is preferably 5-7%, more preferably 5%; and the extraction time is preferably 3-4 h. The present invention has no special requirement for the amount of the ammonia water, and an amount that can completely immerse the rice husk can be used. The present invention utilizes the ammonia water for extraction, which is beneficial to increase the adsorption of the rice husk. After completion of the ammonia water extraction, the present invention preferably further includes washing the extracted rice husk to neutral and drying. In the present invention, the drying temperature is preferably 60-80° C. The present invention has no special requirement for the drying time, and one that can completely dry the rice husk can be used.

In the present invention, the time of the impregnation is preferably 46-50 h. In the impregnation process of the present invention, the tungsten source solution encloses the rice husk and enters a porous structure of the rice husk.

After completion of the impregnation, the present invention performs solid-liquid separation of an obtained system to obtain a solid material. The present invention has no special requirements for the manner of solid-liquid separation, and a solid-liquid separation manner well known in the art can be used. Specifically, in an embodiment of the present invention, excess liquid is poured away to leave only the solid material.

After obtaining the solid material, the present invention roasts the solid material to obtain the biological morph-genetic WO₃ photocatalyst.

Preferably, the present invention further includes sequential washing and drying of the solid material prior to the roasting. The present invention preferably uses distilled water for the washing. In the present invention, the drying temperature is preferably 60-80° C., more preferably 60° C. The present invention has no special requirement for the drying time, and one that can completely dry the rice husk can be used.

In the present invention, the roasting temperature is preferably 540-550° C., and the holding time is preferably 4-6 h; the roasting atmosphere is preferably an air atmosphere. The present invention preferably rises from room temperature to the roasting temperature, and the rising rate is preferably 1.5-2° C./min. In the roasting process of the present invention, a porous morph-genetic structure of the rice husk is opened, the tungsten source replicates the porous structure of the rice husk, and at the same time, the tungsten source reacts with carbon in the rice husk and oxygen in the air to form the biological morph-genetic WO₃. In this process, the carbon in the rice husk is inevitably doped into a lattice of the WO₃, which facilitates transfer between charges in the lattice of the WO₃, reduces a forbidden band width of the WO₃, and improves the photocatalytic reaction performance of the WO₃.

After the roasting, the present invention preferably further includes grinding a roasted product to obtain the biological morph-genetic WO₃ photocatalyst. The present invention has no special requirement for the specific implementation manner of the grinding, and a grinding manner well known in the art can be used.

The present invention provides a biological morph-genetic WO₃ photocatalyst prepared by the preparation method described in the above solution. The biological morph-genetic WO₃ photocatalyst of the present invention replicates a silicon-carbon network structure of a rice husk to have a large number of micropores and mesopores, present a distinct hierarchical structure, and have a larger specific surface area and better adsorption performance than a commercially available WO₃; the specific surface area is up to 199.18 m²/g, the average pore diameter is 5 to 6 nm, and the pore size is mainly distributed between 2 and 12 nm. In the present invention, the biological morph-genetic WO₃ photocatalyst is preferably a nanoparticle having a particle diameter of preferably 40-50 nm. The biological morph-genetic WO₃ photocatalyst of the present invention is inevitably doped with a small amount of carbon, and the doped carbon facilitates transfer between charges in a lattice of the WO₃, reduces a forbidden band width of the WO₃, and improves the photocatalytic reaction performance of the WO₃.

The present invention provides an application of the biological morph-genetic WO₃ photocatalyst described in the above solution in treating methylene blue wastewater. The present invention has no special requirement for the manner of the application, and an application manner well known in the art can be used. In the present invention, the concentration of methylene blue in the methylene blue wastewater is preferably 5-30 mg/L, more preferably 10 mg/L. In the present invention, the dose of the biological morph-genetic WO₃ photocatalyst is preferably 500-600 mg/L. The present invention preferably treats the methylene blue wastewater under irradiation and agitation conditions. In the present invention, the irradiation is preferably natural lighting, and specifically, in an embodiment of the present invention, a 300 W xenon lamp is used to simulate natural sunlight. The present invention has no special requirement for the rate of the agitation, and an agitation rate well known in the art can be used. In the present invention, the time of the treatment is preferably 3-4 h.

The biological morph-genetic WO₃ photocatalyst and preparation method and application thereof provided by the present invention are described in detail below with reference to embodiments, but the embodiments may not be construed as a limitation to the protection scope of the present invention.

### Embodiment 1

Rice husk pretreatment: Take a certain amount of rice husk, wash with clear water for 3 times to remove a surface impurity, impregnate with hydrochloric acid having a mass concentration of 5% for 3 h, and wash with distilled water to neutral; extract the washed rice husk with dilute ammonia water having a mass concentration of 5% for 3 h, pour excess liquid off, then wash with distilled water to neutral, and dry in an oven at 60° C.

Rice husk impregnation: Dissolve 0.158 g, 0.793 g, 1.58 g and 4.76 g of WCl₆ in 40 mL of ethanol solvent respectively to form a uniform dark blue tungstate solution; completely impregnate 50 g of dried rice husk into the tungstate solution for 48 h; after the impregnation is completed, wash with distilled water until the surface of the rice husk is colorless, and dry in an oven at 60° C.

Rice husk roasting: Place the dried rice husk in a muffle furnace at a heating rate of 2° C./min, roast at 550° C. for 4 h in an air atmosphere, and grind to prepare a biological morph-genetic WO₃ sample. Label four WO₃ samples as A-WO₃, B-WO₃, C-WO₃ and D-WO₃, respectively.

Label a commercially available WO₃ powder as E-WO₃.

Structural Characterization

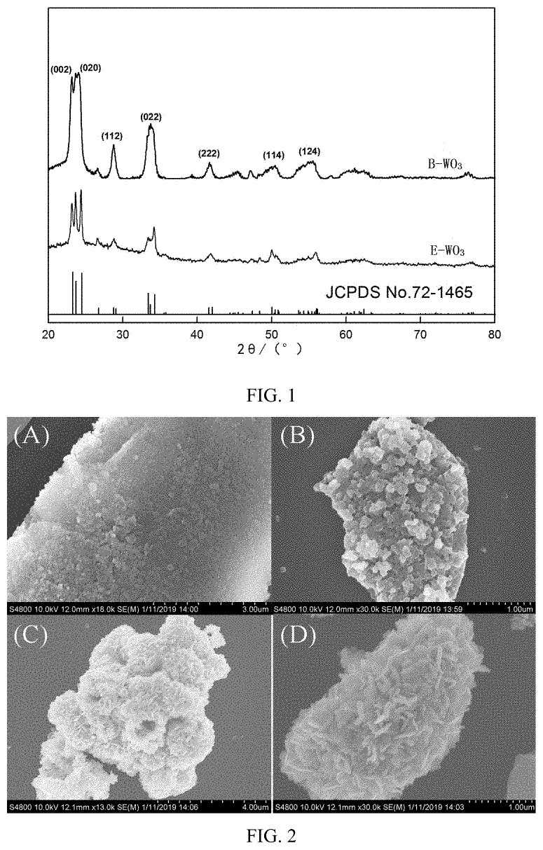

FIG. 1 is an X-ray diffraction (XRD) spectrum of B-WO₃ and E-WO₃. It can be seen from FIG. 1 that characteristic diffraction peaks of B-WO₃ and E-WO₃ at 2θ=23.05°, 24.21°, 28.76°, 33.79°, 41.67°, 50.54° and 54.22° can correspond to (002), (020), (112), (022), (222), (114) and (124), respectively, which are substantially identical to WO₃ of Joint Committee Powder Diffraction Standards (JCPDS) No. 72-1465. In addition, B-WO₃ has a better diffraction peak and a stronger diffraction line than E-WO₃. A full width at half maximum of the diffraction peak is close to a width measured by an instrument, indicating that B-WO₃ has good crystallinity and small size. According to the Scherrer formula

$$D = \frac{K ( λ )}{β ( θ ) , cos ( θ )}$$

(where D represents a grain diameter, K is a constant, 0.89; λ is a characteristic wavelength of an X-ray; θ is a diffraction angle; β(θ) is a half-peak width of the diffraction peak), an average grain size of B-WO₃ is calculated as 48 nm, and an average grain size of E-WO₃ is calculated as 93 nm, indicating that the rice husk effectively inhibits grain growth.

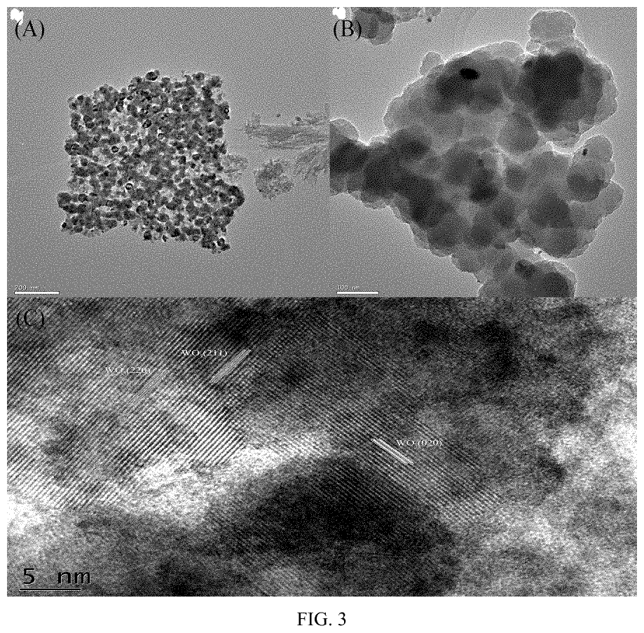

FIG. 2 is a scanning electron microscope (SEM) photograph of B-WO₃ and E-WO₃. The morphology of B-WO₃ and E-WO₃ can be directly observed by a SEM, and the image has a strong three-dimensional effect. FIG. 2 (A) and (B) are SEM photographs of B-WO₃ at different magnifications, and FIG. 2 (C) and (D) are SEM photographs of E-WO₃ at different magnifications. It can be seen from FIG. 2 (A) that the morphology of B-WO₃ is a spherical structure, and the morphology of the WO₃ can be more clearly seen from (B); the surface structure of WO₃ is porous, effectively replicating a biological structure of the rice husk itself, and regularly growing on the surface of a template (i.e., the rice husk); the particle size is about 40-50 nm, which is basically consistent with the XRD grain size, and belongs to a nano-scale particle. It can be clearly seen in FIG. 2 (C) and (D) that E-WO₃ has a rod-like structure but does not have a hierarchical porous structure.

FIG. 3 is a transmission electron microscope (TEM) photograph of B-WO₃. A TEM can be used to not only observe the morphology of B-WO₃, but also deeply observe the inside; the resolution of the TEM is higher than the SEM. It can be seen from FIG. 3 (A) that, B-WO₃ is composed of a plurality of WO₃ grains growing on different crystal faces, with a relatively compact surface formed, and a relatively complete particle; it can be clearly seen from (B) that the grains are tightly connected, with a relatively large specific surface area; (C) shows lattice fringes of B-WO₃, which are uniformly distributed. Compared with the data of a JCPDS standard card, the spacing of the three sets of lattice fringes is 2.63 nm, 3.03 nm and 3.78 nm, which correspond to faces (220), (211) and (020) thereof, indicating that the rough surface of B-WO₃ is composed of uniformly dispersed tungsten trioxide nanoparticles, and also indicating that B-WO₃ uniformly replicates a silicon-carbon network structure and can further suppress the aggregation of tungsten trioxide.

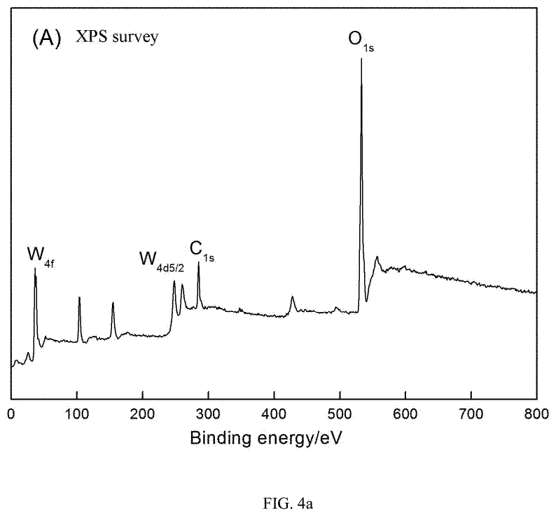

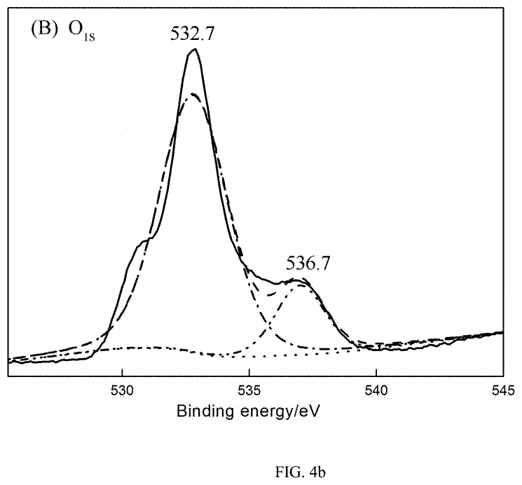

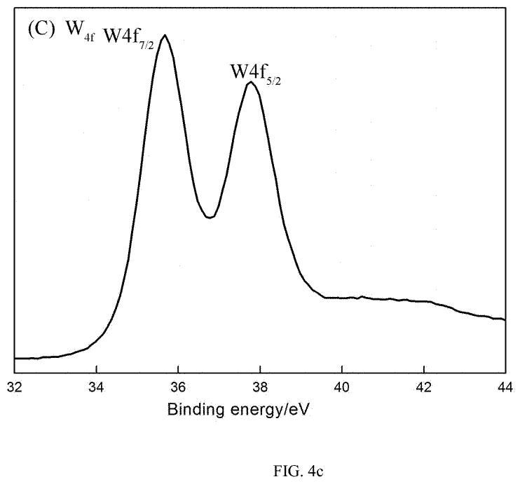

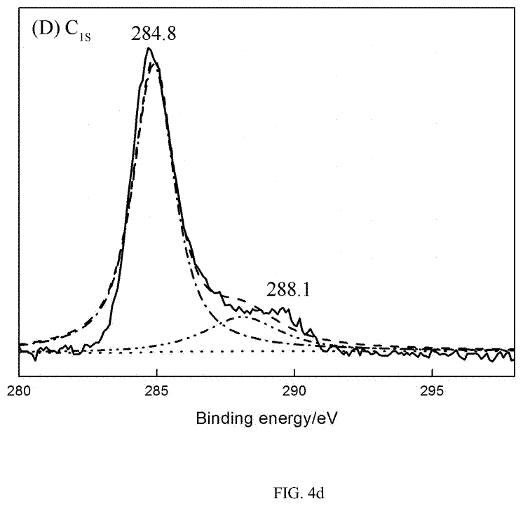

In order to study the elemental composition and surface chemical state of B-WO₃, an x-ray photoelectron spectroscopy (XPS) survey analysis is carried out, and the results are shown in FIG. 4. FIG. 4 (A) is an XPS full spectrum of B-WO₃, proving that elements of B-WO₃ are mainly composed of W, O, C, and Si. In FIG. 4, (B) is an XPS spectrum of O₁ₛ. Background-removed O₁ₛ is peak-differentiated and fit by using Lorentzian-Gaussian in an Xpseak4.1 program, and the O₁ₛ spectrum can be divided into two peaks of 532.7 and 536.7 eV. The peak at the binding energy of 532.7 eV is related to an oxide adsorbed on the surface of B-WO₃, and the peak at the binding energy of 536.7 eV belongs to hydroxyl oxygen on the surface of B-WO₃, thereby improving photocatalytic performance. In FIG. 4, (C) is a high-resolution XPS spectrum of a main element W_{4f}. It can be seen that two peaks appear in the figure, which are located at the binding energy of 35.6 eV and 37.7 eV, respectively, and are generated by spin-orbital energy splitting of W_{4f} (W4f_{5/2} and W4f_{7/2}); an electron binding energy difference of W4f_{5/2} and W4f_{7/2} is 2.1 eV, indicating that W exists in a positive hexavalent state. In FIG. 4, (D) is a high-resolution XPS spectrum of a main element C₁ₛ, which is composed of bond energy of two peaks, namely 284.8 eV and 288.1 eV; 284.8 eV, a primary peak, is generally considered to be caused by carbon source pollution or air pollution calibrated by a reference peak; 288.1 eV, a secondary peak, mainly constitutes a C═O chemical bond, which is attributed to a small amount of carbon in the rice husk being doped into a lattice of B-WO₃, facilitating transfer between charges in the lattice of B-WO₃.

The specific surface area and pore size of the photocatalytic material are important factors in determining photocatalytic activity. Therefore, a nitrogen isothermal adsorption curve of B-WO₃ is tested (E-WO₃ does not have a hierarchical porous structure, so that only B-WO₃ is characterized). FIG. 5 is a N₂ adsorption-desorption isotherm and a BJH pore size distribution curve of B-WO₃, where (A) is the N₂ adsorption-desorption isotherm of B-WO₃, while (B) is the BJH pore size distribution curve of B-WO₃. Referring to the classification of the International Union of Pure and Applied Chemistry (IUPAC), it can be seen that the adsorption curve belongs to an IV type H3 hysteresis loop, indicating the presence of a micropore and a mesopore; it can also be seen from the BJH pore size distribution curve that the micropore has a larger proportion, indicating that WO₃ has a rich pore structure, which better preserves a hierarchical porous structure of the rice husk, and also proves that the material has good adsorption. A Brunauer, Emmett and Teller (BET) specific surface area of B-WO₃ is 199.18 m²/g, and an average pore size is 5.95 nm, which is mainly distributed between 2 and 12 nm.

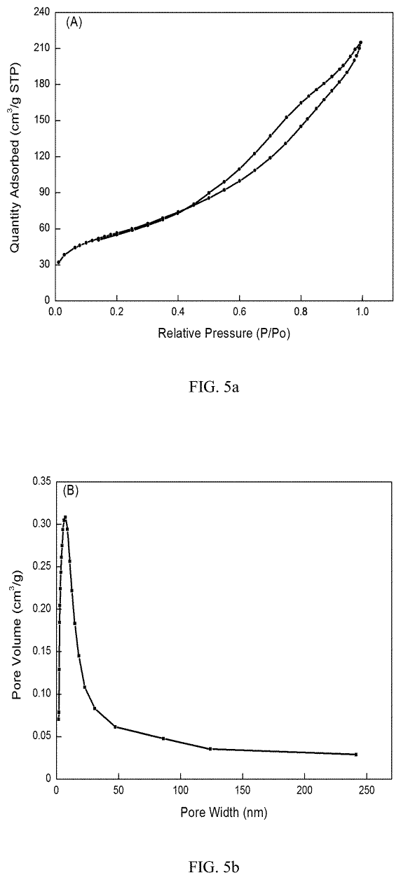

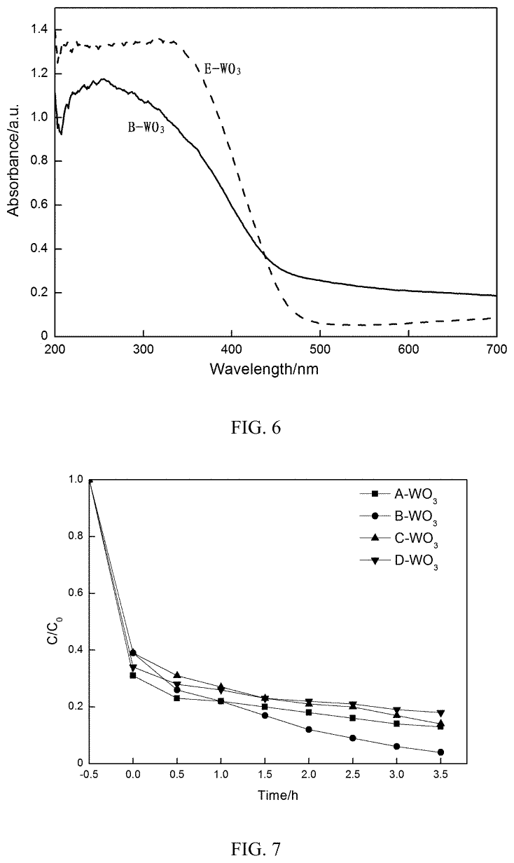

In order to compare the optical properties of B-WO₃ and E-WO₃, the ultraviolet-visible diffuse reflectance spectra of B-WO₃ and E-WO₃ (wavelengths ranging from 200 to 700 nm) are shown in FIG. 6. FIG. 6 shows that E-WO₃ has good absorption in an ultraviolet region, and also has good absorption in a visible region, with an absorption edge being about 473 nm, showing that E-WO₃ has the ability to absorb visible light. An absorption edge of B-WO₃ is about 508 nm, which is larger than E-WO₃. Due to a size difference, the absorption range of B-WO₃ is red-shifted compared to E-WO₃, meaning that more visible light can be absorbed by the biological morph-genetic WO₃ and the catalyst can be excited to produce more electron-hole pairs. According to the formula Eg(eV)=hc/λ (where Eg(eV) is a band gap energy; h is a Planck constant; c is the speed of light; and λ is an absorption wavelength), a forbidden band width is calculated, and by calculation, the forbidden band width of B-WO₃ is 2.44 eV, and the forbidden band width of E-WO₃ is 2.62 eV; it is obvious that the forbidden band width of B-WO₃ is smaller than the forbidden band width of E-WO₃, so that an electron transition requires less energy, which is favorable for a photocatalytic reaction.

### Application Example

Commercially available E-WO₃ and prepared A-WO₃, B-WO₃, C-WO₃ and D-WO₃ samples were placed in 100 mL of methylene blue solution with different initial concentrations and a volume of for a degradation test, and the degradation rate was calculated. A dark adsorption was carried out for 30 min before irradiation, so that the catalyst-dye reached an adsorption-desorption equilibrium, and a 300 W xenon lamp was used as a light source to simulate natural sunlight. During the experiment, the mixture was continuously agitated, and 2 mL was taken at an interval of 30 min; the mixture was filtered through a 0.22 μm organic filter membrane, and then the absorbance of the mixture was measured at 665 nm by an ultraviolet-visible spectrophotometer. The degradation rate of methylene blue, equal to (1−C/C₀)×100%, was calculated, where: Co is the absorbance of the methylene blue before catalysis, and C is the absorbance of the methylene blue at a certain time.

1. Effect of Concentration of Tungsten Source Solution on Degradation Rate

According to the procedure of Application Example, the A-WO₃, B-WO₃, C-WO₃ and D-WO₃ samples prepared in Embodiment 1 were each placed in 100 mL of methylene blue solution with a concentration of 10 mg/L for a degradation test, and the results are shown in FIG. 7. FIG. 7 shows that A-WO₃, B-WO₃, C-WO₃ and D-WO₃ all have a good degradation effect on the methylene blue after 3.5 h of irradiation. It is also found that, the degradation rate of the obtained catalyst on the methylene blue first increases and then decreases as the concentration of the tungsten source solution increases, indicating that the concentration of the tungsten source solution has an important effect on the catalytic performance of the photocatalyst. This may be due to the fact that the different concentrations of the tungsten source solution result in a difference in the surface area and particle size of the finally obtained photocatalyst. As can be seen from FIG. 7, when the amount of the rice husk is 50 g and the concentration of the tungsten source solution is 0.793 g/40 mL, the degradation effect of the obtained photocatalyst (i.e. B-WO₃) on the methylene blue is the best.

2. Photocatalytic Comparison Test

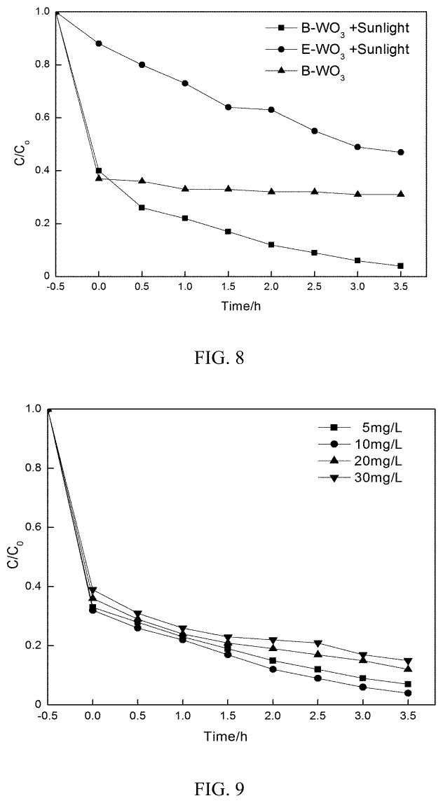

The photocatalyst was separately added to three methylene blue solutions with an initial concentration of 10 mg/L and a volume of 100 mL; 50 mg of B-WO₃ was respectively added to two of the methylene blue solutions, and 50 mg of E-WO₃ was added to the remaining methylene blue solution. The degradation under different conditions is shown in FIG. 8. In FIG. 8, “B-WO₃+Sunlight” represents first dark adsorption for 30 min and then irradiation for 3.5 h after the addition of B-WO₃; “E-WO₃+Sunlight” represents first dark adsorption for 30 min and then irradiation for 3.5 h after the addition of E-WO₃; and “B-WO₃” represents first dark adsorption for 30 min and then continued dark treatment for 3.5 h after the addition of B-WO₃. FIG. 8 shows that the 30 min dark adsorption of added E-WO₃ only degraded 12% of methylene blue, which was due to poor adsorption of the commercially available WO₃ powder with no hierarchical porous structure. The 30 min dark adsorption of B-WO₃ decreased the concentration of the solution by nearly 60%, and the 3.5 h continued irradiation-free treatment decreased the concentration of the solution by about 69%, indicating that B-WO₃ has a larger specific surface area, which is consistent with the BET characterization result. The first dark adsorption for 30 min and then irradiation for 3.5 h after the addition of B-WO₃ degraded about 96% of the methylene blue, indicating that the hierarchical porous structure of the rice husk as a template had a strong adsorption effect. Under the irradiation of the xenon lamp, B-WO₃ showed strong photocatalytic activity and could effectively degrade the methylene blue solution.

3. Effect of Initial Concentration of Methylene Blue (MB) on Degradation Rate

In order to study the effect of the initial concentration of the MB on the degradation rate, four initial concentrations of the MB were selected, namely, 5 mg/L, 10 mg/L, 20 mg/L and 30 mg/L. B-WO₃ was selected as the photocatalyst, with a dose of 50 mg, and other parameters and steps were the same as those in Application Example. The degradation results are shown in FIG. 9. It can be seen from FIG. 9 that when the other conditions were constant, as the initial concentration increased, the degradation rate of the MB was 93%, 96%, 88%, and 85%, respectively. It indicates that, when the initial concentration of the MB was 5 mg/L, an active site of the dye adsorbed on the surface of the photocatalyst did not reach a dynamic equilibrium; when the initial concentration increased to 10 mg/L, the active site reached a dynamic equilibrium point; when the initial concentration continued to increase, the active site of a dye molecule adsorbed on the surface of the photocatalyst increased, so that a site of a hydroxyl radical and a superoxide radical adsorbed on the surface of the photocatalyst decreased, resulting in a decrease in the degradation rate.

4. Effect of WO₃ Dose on Degradation Rate

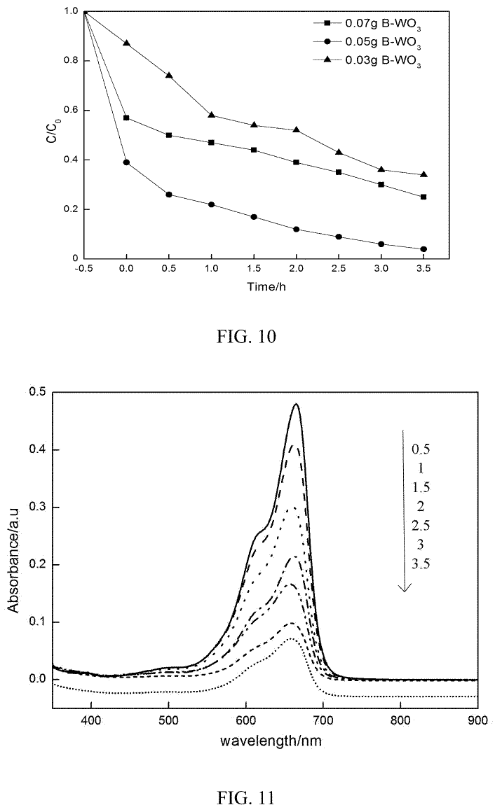

In order to study the effect of WO₃ dose on the degradation effect of the MB, the initial concentration of the MB was 10 mg/L, the photocatalyst added was B-WO₃, and other conditions were the same as those in Application Example. The results of different B-WO₃ doses on the degradation rate of the MB are shown in FIG. 10. It can be seen from FIG. 10 that, as the dose of the photocatalyst increased, an active center provided by the photocatalyst increased, and the adsorption was improved; when the adsorption of the photocatalyst to the dye reached a dynamic equilibrium, an excessive catalyst would affect the absorption of light energy, thereby affecting the number of hydroxyl radicals and superoxide radicals, and hole-electron pairs, and affecting the photocatalytic effect.

5. Mechanism of Photocatalytic Performance

FIG. 11 is an ultraviolet-visible absorption spectrum of B-WO₃ for degrading the methylene blue (the dose was 50 mg, the concentration of the methylene blue was 10 mg/L, and other conditions were the same as those in Application Example). As the irradiation time of the xenon lamp increased, the absorbance of the methylene blue gradually decreased, the concentration of the methylene blue decreased, and after 3.5 h, the solution was almost colorless, and the degradation rate was 96%, indicating that B-WO₃ had a high photocatalytic degradation rate on the MB in a short time.

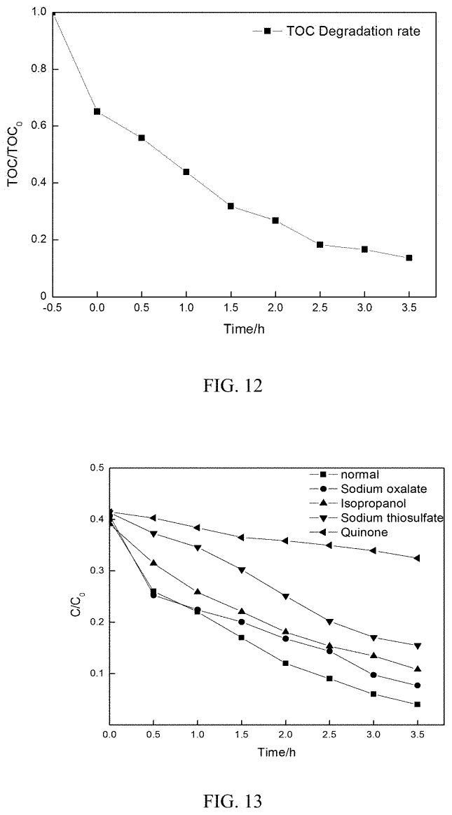

When B-WO₃ degraded the methylene blue solution, a total organic carbon (TOC) concentration varied with the reaction time. The results are shown in FIG. 12. FIG. 12 shows that as the reaction continued, the TOC concentration gradually decreased, and after 3.5 h of irradiation, the removal rate of TOC was 86%, whereas the degradation rate of the methylene blue was 96%, indicating that this process was not a simple decolorization reaction, but a process of deep oxidation and mineralization.

In summary, when the initial concentration of the methylene blue solution was 10 mg/L and the dose of the B-WO₃ catalyst was 50 mg, the decolorization efficiency was the best. Therefore, B-WO₃ was selected to photocatalyticly degrade 100 mL of methylene blue solution with an initial concentration of 10 mg/L under a xenon lamp to capture an active species. 1 mmol sodium oxalate, isopropanol, sodium thiosulfate and p-benzoquinone were respectively added to the solution, where sodium oxalate served as a hole (h⁺) capturing agent, isopropanol served as a hydroxyl radical (.OH) capturing agent, sodium thiosulfate served as an electron (e⁻) capturing agent, and p-benzoquinone served as a superoxide radical (.O2⁻) capturing agent. The results of the degradation experiment were compared to determine a main active species of the MB degraded by the B-WO₃. It can be seen from FIG. 13 that during the photodegradation of the MB, B-WO₃ had a strong inhibitory effect on p-benzoquinone and sodium thiosulfate, but the inhibition on sodium oxalate and isopropanol was not obvious, indicating that .O2⁻ was a main active substance.

The mechanism of the photodegradation of the MB by the WO₃ can be inferred according to the results of the capture experiment. When an irradiation energy was greater than a forbidden band width of the WO₃, an electron would be excited from a valence band to a conduction band, and a hole h⁺ would be generated near the valence band; the electron captured an oxide molecule to generate a superoxide radical (.O₂⁻), and the h⁺ in the valence band oxidized a water molecule to generate a hydroxyl radical (.OH); .the O₂⁻, e⁻ and .OH oxidized a MB molecule adsorbed on the surface of the WO₃, and finally most of MB molecules were oxidized, thereby decolorizing the methylene blue solution.

It can be seen from the above that the biological morph-genetic WO₃ has excellent performance in degrading the methylene blue solution; the source of the material is simple, and the structure of the rice husk is fully utilized, reducing the cost of treating dye wastewater, and having potential development and application prospects.

The above descriptions are merely preferred implementations of the present invention. It should be noted that a person of ordinary skill in the art may further make several improvements and retouches without departing from the principle of the present invention, but such improvements and retouches should also be deemed as falling within the protection scope of the present invention.

1. A preparation method of a biological morph-genetic WO₃ photocatalyst, comprising the following steps: impregnating a rice husk into a tungsten source solution, and roasting an obtained solid material after solid-liquid separation to obtain the biological morph-genetic WO₃ photocatalyst.

2. The preparation method according to claim 1, further comprising: sequential washing, acid leaching and ammonia water extraction of the rice husk prior to the impregnation.

3. The preparation method according to claim 2, wherein an acid solution used for the acid leaching is hydrochloric acid; the mass concentration of the hydrochloric acid is 5-7%, and the time for the acid leaching is 3-5 hours (h).

4. The preparation method according to claim 2, wherein the mass concentration of ammonia water used in the ammonia water extraction is 5-7%, and the extraction time is 3-4 h.

5. The preparation method according to claim 1, wherein a tungsten source of the tungsten source solution is calcium tungstate or tungsten chloride; a solvent of the tungsten source solution is ethanol or methanol; a ratio of the tungsten source to the solvent in the tungsten source solution is (0.1-5) g:40 mL.

6. The preparation method according to claim 5, wherein the time of the impregnation is 46-50 h.

7. The preparation method according to claim 1, wherein the roasting temperature is 540-550° C., and the holding time is 4-6 h; the roasting atmosphere is an air atmosphere.

8. The preparation method according to claim 7, wherein the room temperature is raised to the roasting temperature, and the rising rate is 1.5-2° C./min.

9. A biological morph-genetic WO₃ photocatalyst prepared by the preparation method according to claim 1.

10. A biological morph-genetic WO₃ photocatalyst prepared by the preparation method according to claim 2.

11. A biological morph-genetic WO₃ photocatalyst prepared by the preparation method according to claim 3.

12. A biological morph-genetic WO₃ photocatalyst prepared by the preparation method according to claim 4.

13. A biological morph-genetic WO₃ photocatalyst prepared by the preparation method according to claim 5.

14. A biological morph-genetic WO₃ photocatalyst prepared by the preparation method according to claim 6.

15. A biological morph-genetic WO₃ photocatalyst prepared by the preparation method according to claim 7.

16. A biological morph-genetic WO₃ photocatalyst prepared by the preparation method according to claim 8.

17. An application of the biological morph-genetic WO₃ photocatalyst according to claim 9 in treating methylene blue wastewater.

18. An application of the biological morph-genetic WO₃ photocatalyst according to claim 10 in treating methylene blue wastewater.

19. An application of the biological morph-genetic WO₃ photocatalyst according to claim 11 in treating methylene blue wastewater.

20. An application of the biological morph-genetic WO₃ photocatalyst according to claim 12 in treating methylene blue wastewater.
